(19) United States
(12) Patent Application Publication
(10) Pub. No.: US 2021/0237361 A1
(43) Pub. Date: Aug. 5, 2021

(54) 3D Printer for the Production of Spatial Plastic Molded Parts

(71) Applicants: Entex Rust & Mitschke GmbH, Bochum (DE); NOVO-TECH GmbH & Co. KG, Aschersleben (DE)

(72) Inventors: Holger Sasse, Aschersleben (DE); Harald Rust, Bochum (DE)

(73) Assignees: Entex Rust & Mitschke GmbH, Bochum (DE); NOVO-TECH GmbH & Co. KG, Aschersleben (DE)

(21) Appl. No.: 17/053,823

(22) PCT Filed: Mar. 26, 2019
(86) PCT No.: PCT/EP2019/000095

§ 371 Date: Nov. 9, 2020

(30) Foreign Application Priority Data
May 23, 2018 (DE) 102018004312.7
Jun. 1, 2018 (DE) 102018004369.0
Jun. 23, 2018 (DE) 102018005019.0
Jan. 31, 2019 (DE) 102019000712.3

(51) Int. Cl. B29C 64/393; B29C 64/357; B29C 64/118; B29C 64/209; B29C 64/321; B33Y 10/00; B33Y 70/00; B33Y 50/02; B33Y 40/00

(52) U.S. Cl. CPC B29C 64/393; B29C 64/357; B29C 64/118; B29C 64/209; B33Y 40/00; B33Y 10/00; B33Y 70/00; B33Y 50/02; B29C 64/321

(57) ABSTRACT

3D printing of moldings takes place by an extruder in which solid plastic is melted, the melt being discharged through a die which can be closed completely or partially or opened completely or partially and the melt which is not discharged through the die is returned into the extruder.

### TECHNICAL FIELD

The present disclosure related to a 3D printer for the production of spatial plastic molded parts.

### BACKGROUND

3D is the abbreviation for three-dimensional. In the past, printers were only suitable for two-dimensional works. For some time now, 3D-printers have also been used for three-dimensional works.

The material is applied either point by point and/or as material threads/strips/tapes. The material threads/strips/tapes can be short or long. In any case, the material points and/or material threads string together so that a desired molded part is created.

### SUMMARY

With the 3D printer, spatial molded parts can also be made from thermoplastic materials. It is also an advantage to bring the plastic into a molten form before application. The molten plastic is brought to the point of application through a die. The die forms the print head. The pint of application is a point at which the production of the molded part shall begin or be continued. In the coordinate system with three axes (X-axis, Y-axis, and Z-axis), the point is determined by the values on all axes. There are, amongst others, the following options:

The die is moved in an upright/vertical position over a fixed base in a horizontal plane (determined by the X-axis and Y-axis). Thereby, the extruder can be moved together with the die. This solution is the better option for smaller extruders. The extruder is then preferably held together with the die in a movable/displaceable housing part, which in turn is held in a movable/displaceable housing part, whereat the directions of movement of the two housing parts are arranged crosswise to one another so that every position can be reached on the plane. The adjustment of the device to a specific construction product or the changeover to a different construction product can be effected by the control system of the device. In the case of larger construction parts such as building parts or entire buildings, it is of advantage if the extruder is also moved. Then a guidance along the walls of the building is provided for the movement of the extruder so that large movements can be made by moving the extruder along the walls. In addition, the extruder can also be arranged in that way that it can be swiveled in order to be able to lay melding tapes side by side. As an alternative to the pivoting movement of the extruder, the die can also be adjusted. Sliders are particularly suitable for this purpose by which the melt leaving the extruder can be directed to the side of the wall.

The base is moved under a fixed, upright/vertical die into a horizontal plane (determined by the X-axis and the Y-axis).

The die can be moved in an upright/vertical position above a base in a horizontal plane (determined by the X-axis and Y-axis). At the same time, the base can be moved under the die in a horizontal plane (determined by the X-axis and Y-axis).

The die is moved vertically in an upright/vertical position for adjustment to the respective height of the point (on the Z-axis).

The base is moved in upright/vertical position of the die for adjustment to the respective height of the point (on the Z-axis).

Both the die and the base can be moved uprightly/vertically for adjustment to the respective height of the point (on the Z-axis).

The movements are preferably carried out computerized. It is of advantage to use the data from a computerized drawing program by which the molded part is constructed/pictured for both the movement of the die and/or the base. The best-known drawing/construction program is the CAD program. This program as well as other drawing programs can serve as the basis for the software development.

Regardless of this, there are control programs that can be used, either directly or with minor changes, for the 3D printing according to the disclosure. Such control programs for the movement of the print head/die can also be control programs from other machines, for example milling automatons. Such control systems are able to perform the finest steps in all directions with one tool, as well on a straight line as on a curved path. One only has to enter the data that describe the position of the melt points/threads/tapes/strips. Such control systems can also operate within wide limits with most different speeds. Such control systems are also able to bridge a movement to another usage site at high speed, i.e. at a much higher speed than the working speed.

If the moldings are even, an even discharge of the melt from the die will be possible. Such uniform molded parts are, for example, tubular molded parts. Tubular molded parts similar even shaped parts are extremely rarely produced by means of a 3D printer, because all conventional manufacturing processes are economically superior to the production using a 3D printer. This is different with uneven molded parts. This means, that the more uneven a molding is, the more economically it can be produced by using a 3D printer.

In the sense of the present disclosure, every molded part is irregular, which requires a changed melt outlet. This is the case with changes in thickness as well as with breakouts/breakthroughs in walls, but also already at corners. While changes in thickness can be taken into account with a change of the die movement/base movement and/or with a change in the amount of discharge from the die per unit of time, an interruption/change in the melt flow may become necessary in the event of breakouts/breakthroughs. Even the production of products with different dimensions can make 3D printing according to the disclosure economical. Regardless of this, it may be advantageous to print out the desired moldings only on request to avoid stockpiling with the aid of the 3D printer according to the disclosure.

It is known to produce the melt by means of a melting device, which is known in principle from the adhesive technology. In adhesive technology, a wire or rod made of adhesive material is pushed into a heating devise (glue gun) and liquefied at the tip. The liquefied material is pushed out of the heating device with the wire or rod. The discharge of the adhesive is determined by the pressure/feed rate of the wire or rod. When this technique is used to melt a thermoplastic, a wire or rod made of thermoplastic is provided instead of the wire or rod made of adhesive material.

The disadvantage of this technology is that large quantities of plastic material per unit of time have not yet been available in this way. For an application of the 3D printer for an industrial production of molded parts, however, this is the prerequisite.

In fact, proposals for the use of extruders for the melting of thermoplastic materials for the 3D printer are known, for example, from DE102016213439A1 and EP3020550B1.

However, at the EP3020550B1 it concerns single-screw extruders the task of which is to feed the plastic into a print head in which the plastic is to be melted by heating. Three single-screw extruders are arranged side by side, each of the single-screw extruders is intended for a different material, for example, a differently colored material. The use of two extruders to change the material can be marginal, because one extruder is always unused. With three extruders, economy seems impossible.

The DE102016213439A1 leaves open how the plastic is melted. The only requirement is that the plastic is melted before it leaves the die.

Melting in the print head has the disadvantage that if the printing process is interrupted, molten material remains in the print head. There, a so-called dead space is formed in which there is a risk of a very disadvantageous change in the plastic.

An object of the disclosure is to improve the handling of the melt in 3D printing with an extruder. This is achieved with the features of the main claim. The subclaims describe preferred execution examples.

Important are a closure with which a safe and advantageous adjustment of the amount of melt to the respective need can be achieved and an extruder with a melt volume that is sufficient for the respective requirement.

Here, a displaceable die and/or an extruder is optionally provided, the screw/spindle of which is adjustable in axial direction and forms the adjusting element for a closure/plug of the die from which the melt is discharged during printing. By moving the screw/plug, the die can be opened completely or partially or closed completely or partially.

Optionally, the screw/spindle forms a tip that at least extends in the closed position into the die opening. This can prove to be advantageous if the molded part has small dimensions and a low weight. Then the limitation of horizontal freedom of movement associated with the upright/vertical position of the screw/spindle will be of no consequence with the horizontal freedom of movement of the base.

However, there are also larger molded parts, the dimensions and weight of which make the movement of the molded part and a base/worktable supporting the molded part difficult. When the printing according to the disclosure is applied to the structures/buildings, a movement of the molded part structure/building is practically impossible. Then the entire system with the extruder is moved.

In the case of a screw/spindle extending into the die, the die opening or the tip of the screw/spindle has a shape which tapers in the direction of the flow of the melt.

The screw tip/spindle tip can have a wedge profile. Then the die/die opening is adapted to that.

The die opening and the screw tip/spindle tip preferably have a conical shape.

The screw tip/spindle tip can also have a spherical shape or another, in particular spherical, round shape. With such a tip, a tapering die as well as a die with cylindrical opening can be combined.

With the opening of the die tapering in the direction of the melt flow can correspond a screw tip/spindle tip, which tapers in the same way as die opening and moves into the die with an axial movement of the screw/spindle and closes the die partially or completely, or moves out of the die with an axial movement of the screw/spindle and opens the die completely or partially.

Depending on the diameter of the screw tip/spindle tip, the screw tip/spindle tip can in the closed position project beyond the tip of the die. Then the screw tip/spindle tip is smaller in diameter than the die opening at that end which points in the direction of the flow of the melt.

Alternatively, the screw tip/spindle tip can in the closed position end with the die tip. Then the screw tip/spindle tip has the same diameter as the diameter of the die opening at that end which points in the direction of the flow of the melt.

The screw tip/spindle tip can in the closed position end in front of the die tip. Then the screw tip/spindle tip is larger in diameter than the die opening at that end which points in the direction of the flow of the melt.

In each closed position, the shell surfaces of the screw tip/spindle tip run parallel to the shell surface of the die opening.

With the opening of the die tapering in the direction of the melt flow can correspond a screw tip/spindle tip that tapers differently than the die opening. Thereby the screw tip/spindle tip may have a lower inclination or greater inclination that the die opening in the case of a wedge shape or conical shape with respect to the screw axis/spindle axis. If the screw tip/spindle tip is less inclined, depending on the diameter of the screw tip/spindle tip, an edge of the screw tip/spindle tip comes into contact with the shell surface of the die opening or an edge of the die opening contacts the shell surface of the screw tip/spindle tip.

In the case of a spherical or other round shape of the screw tip/spindle tip, the conical shape of the die opening, depending on the diameter of the screw tip/spindle tip, a contact of the screw tip/spindle tip with the shell surface of the die opening will arise or a contact of the edge of the die opening with the shell surface of the screw tip/spindle tip will arise.

The movement of the screw/spindle is optionally realized by the screw/spindle being arranged in the associated extruder housing so as to be displaceable in the axial direction. Various drives are possible for axial displacement, both hydraulic and mechanical. The hydraulic drives have a hydraulic cylinder/power piston acting in the axial direction on the screw/spindle with a directional control system/step control. With an electronic path measurement, even small paths/adjustments can be measured and controlled.

Electric lifting devices can also be used as drives for the axial movement of the screw/spindle. Electric lifting devices/power pistons are particularly suitable for fast and frequent closing and opening movements. This means that electrical lifting devices/power pistons are particularly suitable for short threads/tapes/strips and correspondingly short melt flow intervals. This applies even more to extremes such as melt points.

Even with the axially movable arrangement, the screw/spindle at the end facing away from the die can be rotated via a motor and a gear. For this purpose, for example, a driving wheel with a splined connection can be located on the screw/spindle. The splined connection allows a displacement of the screw/spindle when the driving wheel is held in the axial direction with the necessary clearance for a rotary movement.

An inexpensive drive connection between the screw/spindle and the drive provides a belt drive with one or more V-belts. The V-belt allows a fixed arrangement of the driving wheel on the screw/spindle with simultaneous displacement. This applies especially to small displacements. The displacements can also be kept to a minimum by adjusting the base, even if the molded parts to be manufactured are of considerable height.

Optionally, instead of or in addition to the axial adjustability of the screw/spindle, an axial adjustability of the die is provided in order to open or to close the die partially or completely. Thereby, the die is either moved against the screw tip/spindle tip or moved away from the screw tip/spindle tip. As drive units for the axial movement of the die, the same drives and control systems are suitable as for the axial movement of the screw/spindle.

Optionally, a slide can be used as a closure.

The dies describe above are particularly advantageous for a system with an uprightly/vertically moving die or uprightly/vertically moving screw/spindle and also for vertically moving and horizontally moving base/worktable. The upright/vertical arrangement allows the downward deposition of the melt. That works particularly well. In addition, the melt has no significant tendency to flow away from the storage position.

In addition, the dies described above can also be used if the dies can be moved horizontally together with the extruder feeding the dies with the melt.

When 3D printing a structure/building as well as other molded parts with great weight and large dimensions, the movement of the system can have great advantages.

The term structure includes large structures which make up an essential part of the building, as well as small structures having the size of a plate or even the size of a brick or other stone, as used for building houses.

When producing structures/buildings, it is possible to build without joints or to limit the number of joints to a number of necessary expansion joints. The expansion joints can advantageously also be designed in such a way that joint tapes can be easily installed subsequently. For adhesive joint tapes, a simple recess/groove with an adhesive surface in the bottom of the recess/grove is sufficient. Corresponding recesses/grooves are molded into the structure of conventional structures, as far as the setting in concrete of the joint tapes has not yet been intended. The recesses/grooves can also be incorporated into the structures/buildings. This is preferably not done retrospectively, but already during production by 3D printing.

Special advantages arise when the joint tapes can be welded to the structure/building produced. For this purpose, the joint tapes and the structure/building must be made of weldable material at least on the weld contact area. Optionally, the structure is made entirely of material that can be welded to the joint tape or a profile is molded into the structure during its manufacture or laminated onto the structure, which can be welded to the joint tape.

The joint tape and the structure/building do not have to be made of the same plastic as a whole for the welding. It is sufficient if the joint tape and/or the structure/building consist of a plastic blend with a plastic content that creates the weldability. Depending on the material, a proportion of less than 40% by weight, preferably less than 30% by weight, even more preferably less than 20% by weight and most preferably less than 10% by weight of weldable material of the joint tape may suffice for the weldability. The percent by weight relates to the total plastic blend for the structure/building and the joint tape.

Weldability can reduce costs significantly. This can include significant savings in assembly. In addition, there is an extremely great advantage where sealing is important. With the welding, a seal is significantly better compared to other connection technologies. The sealing effect is better. Where sealing matters, weld seams can be placed next to each other at a distance, whereby the space between the weld seams can be pressurized with compressed air to check the weld seams.

The welded connection can also be used on construction products other than joint tapes, even independently of the 3D printing.

Such an area of application is formed by plastic windows.

Plastic windows usually have a plastic frame, while the pane is made of glass. The plastic frames are often made of PVC (polyvinyl chloride) or mixtures with PVC. The plastic frames consist of complicated profiles that have to fulfill various functions. The connection to the building is just one function of it. When using the welding technology according to the disclosure, the windows can be welded directly to the structure/building if the above requirements are met. If the structure/building does not meet this requirement, simple plastic profiles can be attached to the structures/buildings or molded in, which can be welded to the plastic window. A simple leg on the outer edge of the plastic window can be sufficient for welding.

The simple leg on the plastic window can, for example, be welded flat on the outside or inside of the structure/building if the leg of the plastic window comes to lie flat on the outside surface or flat on the inside surface of the structure/building wall when it is installed. This is the case if, for example, the leg runs parallel to the front surface of the window. For example, a frame-like intermediate piece made of a z-shaped profile can be helpful for mounting the window within the window opening. The profile is then welded with one leg to the outside or inside of the structure and the other leg to the window frame.

The welding can be made thermally by melting the weld surfaces and then pressing them against each other. Welding can also be carried out cold, using solvent welding. The welding surfaces are coated with a solvent and pressed against each other after swelling. The solvent welding is also suitable for hart PVC, which is mainly used for the window construction. Tetrahydrofuran is known as a suitable solvent.

Where welding is not desired, the window frame can be glued to the structure/building with a suitable adhesive. Suitable adhesives are, for example, two-component adhesives. These adhesives offer high adhesive properties and a long service life.

Penetration of the structure of the structure/building for pipes (water/sewage; electricity; gas; ventilation, etc.) can include installations, such as flanges, which can be welded/glued in the same way as the windows.

When the system moves, it is helpful if the die has not only an open/close function and can not only deposit the melt on a line, but can also simultaneously distribute the melt over an area that is wider than, for example, a melt thread/strip/tape or a melt point. This is the case, for example, when a 3D printer is supposed to erect a wall in one process step. Then the 3D printer should lay the melt across the entire width of the wall. This can be done in points or with threads or with tapes/threads/strips.

Walls can also be produced with the formation of closed layers or with the formation of hollow spaces. There are particular advantages in the formation of hollow spaces if the closed outer layers of the walls are connected to one another by lands and if the lands run at different angles between the layers. For example, the one lands may be inclined at 45 degrees in one longitudinal direction of the walls and the other lands at 45 degrees incline in the opposite longitudinal direction of the walls. Alternatively, the lands can cross each other. This creates a rigid connection and allows ventilation of the walls in case of need; if necessary, the hollow spaces can also be used for routing cables for individual media or all medial found in a building.

Alternatively, the formation of hollow spaces takes place with the formation of uniform thick layers. The hollow spaces can each be closed. This is also possible with the formation of watertight hollow spaces. This is an advantage in the area of building walls being in contact with the ground. The hollow spaces can be designed as desired. Hollow spaces with particular static strength and particularly advantageous deformation behavior under load are of advantage. Suitable hollow spaces, for example, are recreated after closed honeycombs. The closed hollow spaces also offer an advantageous thermal insulation.

Optionally, the hollow spaces are also at least partially interconnected. This can advantageously be used to create an upright/vertical connection between the hollow spaces that moisture that penetrates on the way of diffusion can evaporate upwards.

The above construction can be implemented by laying melt tapes and/or melt threads and/or melt strands and/or melt points. Melt tapes/threads/strands make printing easier by allowing a longer melt flow in the form of melt threads/strands/tapes. Melt threads involve a thin application of melt. Melt tapes/strands have a multiple of the width of melt threads. They can have the same thickness as melt threads but can also have a multiple of the thickness of melt threads. The larger thickness is of advantage when working with a larger application capacity. An interruption of the tapes/threads/strands must also be taken into account for melt tapes/threads/strands. On the other hand, the melt flow is interrupted extremely often when the melt is laid point by point. Electrically operated lifting devices are particularly suitable for point-by-point melt application.

Whereas in two-dimensional printing units only one single layer is created with the printing material, in three-dimensional printing units several layers are laid one on top of the other.

Usually the procedure is carried out line by line in each layer. The line-by-line mode of operation has the disadvantage of considerable empty movements of the printer and/or considerable empty movements of the molded part. There is a significant increase in printing performance if the line-by-line printing is restricted to the bottom surfaces of the molded parts, i.e. is rerouted when an edge of the bottom surface is reached.

Advantageously no interruption in the laying of the changeover to the neighboring line has to take place. The print then takes a meandering course.

If the wall surfaces are treated like a floor surface after completion of a floor surface, the rerouting processes increase. In the case of wall surfaces, preference is given to a direction of movement along the wall surfaces. The new direction of movement can be programmed in this way. In the case of molded parts, the worktable on which the molded parts are built can be rotated until the direction of movement of the printer runs in the direction of a wall. Instead of rotating the worktable or in addition, rotating the extruder with the die and other accessories can make it easier to align the printer movement with the course of the wall to be printed. Even the rotary movability of individual parts such as the die can help to align the direction of movement of the die with a wall.

In the production of structures/buildings, it is of advantage if the extruder, including the die and other accessories for printing over the structure/building, can be moved in any direction.

For the movement, each structure/building can be set up with tracks for the system according to the disclosure. The tracks and/or the extruder with the die can also be height adjustable. The software for the control system should be set up thereon so that when entering the dimensions of the tracks and their location to each other and their height, all the melting tapes/threads/strands are stored in the desired length at the desired location.

A laser control of the system can also be considered. Several lasers are preferably used to direct the extruder with the die to any desired location.

In the case of large structures, it is advisable to manufacture the structures/buildings in sections.

Below there are depicted some of different possible procedures with short and longer melt tapes:

The printer can lay a long tape/thread/strand in the longitudinal direction of the wall. The next long melt tape is also placed in longitudinal direction along the wall, but at the same time somewhat offset, next to the previously laid melt tape/thread/strand. The longer melt tapes/threads/strand can thereby closely adjoin each other. The longer melt tapes/threads/strands can thereby be laid laterally overlapping to each other. The longer melt tapes/threads/strands can be laid to form a horizontal distance from each other. At intervals, a connection of the two distanced longer melt tapes/threads/strands occurs by short melt tapes/threads/strands.

Due to the alternating arrangement of long and short melt strands/threads/tapes and/or offset of the melt strands/threads/tapes, a bracing/composite is generated in every layer of melt strands/threads/tapes. The fact that melt strands/threads/tapes are offset from the melt strands/threads/tapes in the previously laid layer in each new layer also improves the bracing/composite of the melt strands/threads/tapes.

A further improvement can be achieved if alternating (from layer to layer) completely or partially narrower or wider melt tapes/threads/strands are laid. For example, the wider melt tapes/threads/strands can be twice as wide as the narrow melt tapes/threads/strands. Optionally, the relation of the narrower widths to the larger widths is between 1 to 1.1 and up to 1 to 4.

At cross points/junctions of melt tapes/threads/strands it is avoided that melt tapes/threads/strands are placed one on top of the other in one layer. With two layers lying upon each other, it goes without saying that melt tapes/threads/strands lie one above the other.

A constant thickness is preferably maintained in each layer. This is achieved in that longer melt tapes/threads/strands (exemplarily named melt tape 1) end in front of another melt tape/thread/strand (exemplarily named melt tape 2) and start again after the other melt tape 2. The melt tape 1 is thereby interrupted by the melt tape 2.

Proceeding exactly the same at every cross point/junction includes the less good solution compared to other approaches.

It is better to create a bracing at all cross points/junctions. Bracing means that the abutting structures are connected to one another and are integrated into melt tapes/threads/strands of one structure between melt tapes/threads/strands of the other structure. A bracing is formed at crossing melt tapes/threads/strands if the melt tape 2 ends in the next melt layer in front of the melt strip 1 and is deposited anew after the melt tape 1. As a result, the melt tape 1 runs through at this cross point, while the melt tape 2 is interrupted.

Preferably junctions are designed accordingly. With junctions are meant those positions where two walls meet in a T-shape or an L-shape or at which a wall adjoins a floor surface of the molded part, an intermediate floor, a cover, a projection of the structure, or something like that. A bracing/composite is also advantageous at the T-shaped junction.

The T-shaped abutting differs from cross points in that the wall abutting a continuous wall does not continue on the opposite side of the continuous wall. The principle explained above on melt tape 1 and melt tape 2 is preferably maintained, in one layer the melt tape 1 is laid continuously and the melt tape 2 abuts the continuously laid melt tape 1. In a layer above, the melt tape 1 is interrupted in the width of the melt tape 2 and the melt tape 2 extends into this gap.

Junctions can also arise if they form a corner. Then the walls meet in an L-shape. This junction differs from the T-shaped junction in that no wall is continuous (exceeds the corner). Then the melt tape 1 ends in a layer at a distance from the corner which is equal to the width of the melt tape 2, so that the melt tape 2 can be guided/placed in the gap. In the layer lying above, the melt tape 2 ends at a distance from the corner which is equal to the width of the melt tape 1, so that the melt tape 1 can be guided/placed in the gap.

As an alternative to the above corner formation, the melt tape/thread/strand can also be angled at the corner. Thereby, the melt tape/thread/strand is angled and continued at the corner without interruption. In principle, this can be done with any melt tape/melt strand/thread. The best results can be seen with melt tapes/threads/strands from a die with a circular cross-section.

The connection of a wall to a floor surface or the like is preferably solved in the same way as the T-shaped junction because the floor surface is also composed of different melt tapes/threads/strands. This means that melt tapes/threads/strands are deposited on the wall-side edge of the floor to be produced in exactly the same way as for the production of a continuous wall that abuts another wall.

In one layer, a melt tape/thread/strand of the floor to be laid is interrupted over the length that is equal to the width of the melt tape/thread/strand of an abutting wall, so that this melt tape can be guided into this gap.

In the layer provided above, the relevant melt tape/thread/strand of the floor is laid without interruption and the associated melt tape/thread/strand of the abutting wall abuts against the melt tape/thread/strand belonging to the floor.

If a building wall is built up in layers, several melt tapes/threads/strands can lie on one level side by side and/or behind each other. An offset is then preferably provided between the melt tapes/threads/strands of one layer/level and the melt tapes/threads/strands of an overlying layer/level or an underlying layer/level. The offset amounts to at least 1 mm, preferably at least 2 mm, more preferably at least 3 mm and most preferably at least 4 mm. This advantageously leads to a toothing of the different layers.

When laying melt threads, much more melt threads have to be laid than with melt tapes in order to produce the same volume on walls and surfaces.

The extruder can be a twin-screw extruder. A single-screw extruder is preferably used as the extruder, more preferably a planetary roller extruder. All types of extruders mentioned have a feed part in which the plastic intended for printing is filled. The feed part is followed by an extruder section, in which the plastic is melted, homogenized, and brought to the temperature required for printing and in which this temperature is maintained. If necessary, a degassing can also take place, as well as a mixing with additives, additions, and fillers. Optionally, a compound can be used that contains a pre-mix of the plastic with single or multiple or all additives, additions, and fillers.

Particularly large quantities of fillers can be used in the manufacture of construction products. The fillers in the construction business are usually of mineral origin. However, fillers of organic origin are increasingly being used. One example is fine wood particles that are mixed into the plastic.

The more fillers are mixed in, the more the plastic becomes a binding agent. There is an interest in improving the strength of the plastic framework. This happens in particular with natural fibers.

The mixture of plastic with wood particles has its own product name WPC. The proportion of wood is regularly higher than 50% by weight, based on the mixture. The WPC can also achieve a wood content of 60% by weight or 70% by weight.

Construction products must also contain flame retardants if they could be exposed to fire load. The common flame retardants are known. Aluminum hydroxide belongs to the common flame retardants. The greater the proportion of flammable/combustible components in the construction product, the greater the proportion of flame retardants. With a high proportion of wood particles and plastic of more than 70 to 90% by weight, the proportion of flame retardants can amount to 10 to 30% by weight. One of the possible flame retardants is aluminum hydroxide. The proportions of the input material usually also include dyestuffs. The percent by weight relates to the entire construction product.

The melting of the plastic occurs by appropriate heating. The heating can be done by heating the extruder. The heating is possible because conventional extruders are equipped with a temperature control. For this purpose, the housings of the extruders are provided with channels for a heating-cooling agent. The heating-cooling agent is water or oil. For heating a heated heating-cooling agent is fed into the housing. There, the heating-cooling agent partly emits its heat to the plastic. At the same time, the fed plastic warms up due to its constant deformation in the extruder. Thereby, the operating power is converted into heat. After the melt temperature has been reached, the further deformation of the plastic and the associated energy input lead to further heating in case this is not counteracted by cooling. The heating-cooling agent is then used for cooling. Cold heating-cooling agent is fed into the channel of the housing to absorb the heat. Separate heating-cooling circuits are preferably used for heating and cooling.

In the case of extruders constructed on a modular basis (the screw/spindle extends from the drive through all modules to the die), this is done by using separate extruder modules for heating and cooling. Optionally, a separate extruder module can also be applied for a desired degassing. Below this module is referred to as degassing module. The degassing module has a shell opening through which gas can escape. An empty running side-arm extruder is preferably provided at this shell opening. Even more preferably, the side-arm extruder is a twin-screw extruder that rotates without any feed material as if it were supplying material into the degassing module. Thus, the side-arm extruder prevents the melt in the degassing module from escaping through the shell opening. Preferably, a particular short side-arm extruder is used. An induced draft, lying simultaneously against the side-arm extruder detracts gas as a result of intended leakage in the side-arm extruder. The necessary clearance between the screws of the side-arm extruder and the surrounding housing can suffice as a leakage. If necessary, an additional clearance is created between the screws of the side-arm extruder and the surrounding housing. This can be done by machining the screws on the outer circumference.

The side-arm extruder can be arranged laterally or above the degassing module or below the degassing module.

The plastic can be a granulate. At extruders of smaller construction size, the granulate preferably contains a mixture with all the necessary mixture components, which is supplied to the extruder as a prepared compound. This means that the small system does not require a large amount of equipment for the dosing of the blend components. Smaller systems are here extruders with a construction size of less than 70 mm, preferably less than or equal to 50 mm.

In particular in larger plants, the mixtures are entirely or partly produced in the extruder. The various components of the mixture are then dosed into the extruder individually or in pre-mixes or together. After supply of the components of the blend, the smaller quantities of mixtures are dispersed in the plastic or in the plastic melt.

The single-screw extruder and the twin-screw extruder have optionally one or two screws with a reduced conveying effect. Normally, single-screw extruder and twin-screw extruder have a high conveying force, so that there are considerable pressures which make an adjustment to a reduced need of molten plastic difficult.

By reducing the conveying effect, there are reduced pressures which make it easier to adapt to a reduced need.

The conveying effect is preferably reduced by incorporating one or more counter-rotating screw flights into the screw. The incorporation can be done optionally by milling. The previous screw flights are interrupted at distances by milling.

Optionally, the screws of the single-screw extruder and the twin-screw extruder can be provided with a reduced diameter, so that a larger gap is created between the screws and the surrounding housing. The cylindrical screws can also be flattened or recessed on the circumference.

Gaps arise through which the material can draw aside and even flow back. A wanted leakage flow occurs. The larger the gaps, the better the plasticized plastic can flow back in the extruder. This continues until the melt is again seized by the screw and pressed in the direction of the extruder discharge. If no melt is removed from the die, the melt can evade in the way of the leakage flow.

With the single-screw extruder and the twin-screw extruder, adjusting the correct leakage flow is more complicated compared to the situation with a planetary roller extruder.

The leakage flow can be seen as a “driving in a circle” of the melt. In combination with a regulation of the melt outlet at the die, an extremely advantageous device is created because the melt is kept liquid in the extruder and circulated until there is a need for a melt discharge. In this case, the die opens and a desired melt discharge occurs. The extruder is controlled at the die. At the same time, the amount of melt leaving the extruder is replaced by supplying further feed material to the extruder. A filling level control system can be used, especially if the extruder is placed upright instead of lying down.

The greater the amount of melt that is moved, the easier it is to maintain a melt requirement for 3D printing and to regulate the supply.

The leakage flows and the hollow space volume of the extruder are decisive for the amount of melt.

After opening of the die, melt flows off to the 3D printer.

The hollow space of the extruder is the interior of the extruder minus the volume of the screw and other installations that extend into the extruder.

The degree of filling of the extruder can be measured in various ways. This can be done by positioning a sensor in the shell of the feed part. The sensor can include any form of measurement that responds to melt. This includes, for example, pressure, temperature, ultrasonic sound and other sound.

The filling level is preferably determined by weight measurement or by optical volume determination.

If the filling level falls below a predetermined level, the feed material to produce the melt is refilled.

When determining the weight, there are favorable conditions if the weight of the molded part being created on the base/worktable is measured. From this weight, the melt consumption can be calculated. The weight is preferably measured electronically using a microchip.

The electronic measurement can advantageously be carried out at the same time when the base/worktable is in a position of rest so that the measurement results cannot be falsified by accelerating and braking forces. Moreover, the effects of the acceleration and braking forces can also be added or deducted from the results of the weight measurement.

When determining optically the volume, the molded part in progress is measured on the base. There are various ways of doing this. It is of advantage, to measure the smallest distance between the die and the molded part. A laser measuring device is suitable for this.

In any case, the distance measurement is an advantage to ensure constant conditions for the melt application. The values of the distance measurement can then be used not only to control the necessary re-feeding of melt into the extruder, but also the movement of the base/worktable in the axial direction of the die can be controlled.

The reduced conveying effect can also be achieved with a bypass which begins in the conveying direction of the extruder in front of the die and which partially or completely returns the melt to a suitable section of the extruder. Only one part of the melt is returned when the die is partially closed or only partially opened. The melt is returned in total when the die is completely closed. A suitable section for the return of the melt that evaded into the bypass can be the area of the melt production, or a point spaced apart therefrom in the conveying direction of the extruder.

The bypass is a preferably heat-insulated (possibly also heated) pipeline. One end of this pipeline is flanged in conveying direction of the extruder in front of the die to an opening in the shell of the extruder. The other end of this pipeline is flanged in conveying direction of the extruder to a further opening in the shell of the extruder, which is located in the area of the melt production or in conveying direction behind it.

Planetary roller extruders are better suited for 3D printing than the single-screw extruders and the twin-screw extruders. The leakage flow can be generated much more easily with a planetary roller extruder than with a single-screw extruder.

In addition, the planetary roller extruder has other extremely important advantages over the single-screw extruder. These include in particular a much better mixing effect and a much better temperature control.

The planetary roller extruder has a rotating central spindle arranged in the middle of a housing. The central spindle has an outside toothing. Around the outside of the central spindle there are planetary spindles rotating, which are also toothed on the outside and mesh with the central spindle during rotation. The planetary spindles simultaneously rotate in the extruder housing. For this purpose, the extruder housing or the liner in the case of a liner intended inside in the extruder, is equipped with an internal toothing, with which the planetary spindles mesh simultaneously.

The planetary spindles slide with the rear end in the conveying direction of the extruder on a slide ring which is held in the extruder housing. Furthermore, the planetary spindles are held only in the toothing of the central spindle and the internal toothing of the housing.

Also, the planetary roller extruder begins with a drive and ends with the die. In between, the planetary roller extruder can be provided with a one-piece housing that extends over the entire length.

The planetary roller extruder can also be composed of several modules/sections between the drive and the die.

Then a common central spindle extending through all modules is provided between the drive and the die.

The individual modules/sections can take over one or more different tasks. Preferably, all modules/section of the planetary roller extruder are designed in a planetary roller extruder construction. Modules/sections in planetary roller extruder construction can also be combined with modules/sections in other designs. This applies particularly to the feed part. Formerly, the modules/sections for the feed part used to be mostly designed in a single-screw extruder design. In this case, the central spindle continued as a single screw in the module/section for the feed part.

The planetary roller extruders for use in printing 3D molded parts can also have a reduced conveying effect.

This can be achieved in different ways with planetary roller extruders. This is preferably done on the planetary spindles:

The number auf planetary spindles (number of rotating planetary spindles) can be reduced/changed. Depending on the size of the planetary roller extruder/planetary roller extruder module/section, the number of planetary spindles can be up to 24 and more. For smaller sizes, the number of planetary spindles can also amount to 5 or 6. The reduction of the number of planetary spindles by 1 already includes a substantial reduction in smaller sizes. With larger sizes, a comparable reduction only occurs when several planetary spindles are removed. The smaller the number of planetary spindles, the greater the distance between the planetary spindles in the circumferential direction and the easier it will be for the melt to flow back between the planetary spindles.

The reduction in the number of planetary spindles has a limit with 3 planetary spindles.

In addition, the backflow/leakage flow can be influenced very advantageously by changing the number of planetary spindles. Comparable possibilities cannot be found on a single-screw extruder.

After each reduction/change in the number of planetary spindles, the planetary spindles are distributed anew around the circumference of the central spindle in order to ensure an even distribution. If the distribution is even, the central spindle in the housing is better supported and the risk of skipping planetary spindles is reduced. Skipping usually leads to an immediate blockade of the extruder and tooth breakage. At least the wear is reduced by the even distribution of the planetary spindles.

The reduction of the planetary spindles/change in the distribution of the planetary spindles is carried out when the extruder is at a standstill after the die has been removed. In addition, the reduction of the planetary spindles/changes of the distribution occurs in modules/in sections. Thereby, not only the die is removed, but also all modules/sections which in flow direction of the meld follow the module/section the planetary spindles of which are to be reduced and distributed anew. However, the central spindle remains.

Inexperienced operators are advised to us a template for the new distribution, which is pushed onto the central spindle. At the points where the planetary spindles are to be pushed between the central spindle and the surrounding housing, the template has borings with a diameter that is equal to the diameter of the planetary spindles, plus a generous clearance. Thereby, the planetary spindles can easily be pushed at the borings between the central spindle and the associated housing and thereby take a distance from one another which is at least approximately the same.

Experienced operators can renounce the use of a template.

The backflow/leakage flow can also be influenced by a reduced set of teeth. Modern planetary roller extruders have an involute toothing that is also designed as a helical toothing. Their teeth can advantageously be changed considerably. The unchanged toothing of planetary spindles is called normal toothing. Various change options are described below. Advantageously, the spindles with modified toothing described below are all easily interchangeable with each other and with planetary spindles with normal toothing. By changing, the essential effects of the planetary spindles can be strengthened or be reduced at option. The interchangeability of the planetary spindles on the planetary roller extruder is an extreme advantage that cannot be found in comparable form with single-screw extruders.

For the advantageous replacement or change of the backflow/leakage flow by interchanging planetary spindles, there a various versions of planetary spindles available:

The number of teeth will be reduced. The number of teeth can be reduced to three teeth, even down to one number. This can be done subsequently by removing teeth on the planetary spindles. The teeth are preferably removed by milling and a subsequent finishing by grinding. The planetary spindles can also be produced right away with the teeth, just like the planetary spindles on which teeth have been subsequently removed. The remaining teeth are preferably evenly distributed over the circumference of the planetary spindles.

Even if there is only one tooth, the planetary spindles are still adequately guided and supported in the external toothing of the central spindle and the internal toothing of the housing. This is caused by the fact that each tooth winds several times around the planetary spindles along the length of the planetary spindles.

All teeth of the planetary spindles can also be reduced in height if sections remain on the planetary spindles that give the planetary spindles sufficient guidance. Such guide sections can have normal toothing (unchanged toothing), which is preferably located at the ends of the planetary spindles. In addition, it is advantageously to combine such planetary spindles with completely normal toothed planetary spindles in an extruder so that the normal teeth during the rotation around the central spindle push all material out of the tooth gaps of the central spindle and the tooth gaps of the internal toothing of the housing or avoid that material will accumulate in the tooth gaps and sticks there. This can be described as cleaning of the tooth gaps.

Preferably, not all teeth of the planetary spindles are reduced in height. At least one tooth maintains its original height. This can give the planetary spindles the necessary guidance/hold in the external toothing of the central spindle and the internal toothing of the housing, so that the guide sections are not necessary.

In addition. The teeth on the planetary spindles, which are left at their original height, also clean the tooth gaps on the central spindle and the tooth gaps on the internal toothing of the housing.

The height of the teeth can be reduced as when teeth are completely removed, for example, by milling and subsequent finishing by grinding.

The land height is preferably reduced by at least 20%, even more preferably by at least 40% and most preferably by at least 60%.

It is also an advantage if the height-reduced/flattened teeth are rounded on the new head that is being created. This improves the flow behavior of the material when displacing the material in the corresponding tooth gaps of the central spindle and the corresponding tooth gaps of the internal toothing of the housing.

The lands of the planetary spindle teeth can be interrupted in whole or in part at regular intervals or at irregular intervals. A uniform interruption occurs, for example, if the planetary spindles are toothed again in opposite direction after manufacturing of the normal toothing. This leads to a nap structure of the planetary spindle surface. That is why such planetary spindles are also called nap spindles.

The opposite toothing goes down to the bottom of the tooth gaps.

If the opposite toothing is cut less deeply into the planetary spindles, the result is a different planetary spindle surface with more conveying effect.

A uniform interruption is also created by working in in regular intervals circular rotating grooves into the planetary spindles. These planetary spindles are called transversal mixing planetary spindles.

The grooves are usually machined to the tooth root. However, the grooves can be worked in less deeply in order to achieve different properties.

In the same way, the toothing can be varied by changing the multi-flight of the opposing toothing. This means that planetary spindles with a modified number of teeth can be used. Thereby, it can be chosen between planetary spindles with more or less removed teeth.

Depending on the tooth module/tooth dimensions and the pitch circle diameter of the toothing, the normal toothing has a certain number of teeth, rotating around the pitch circle diameter. These teeth wind parallel to each other around the planetary spindles and include the multi-flight of the planetary spindles.

With the same opposing toothing, the naps described above arise. However, teeth can be cut in greater distances into the normal toothing than at the normal toothing. Then, nor naps are created, but lands because the teeth of the normal toothing are interrupted at a greater distance.

The reduction of the number of planetary spindles and the reduction of the number of the number of teeth on the planetary spindles can occur together or individually. The same applies to a bypass. The bypass can occur alone or together with the reduction of the number of planetary spindles and/or the reduction of the number of teeth.

The measures described above have in common that opening arise in the planetary roller extruder through which die melt can flow back, which is not actually required for the 3D printing. This contains a desired leakage flow. The backflow/leakage flow continues until the melt is again seized by the planetary spindles and conveyed in the direction of the die. If there is still no melt taken off for 3D printing or only a small quantity of melt is taken off for 3D printing, then the circular flow of the melt starts again.

When melt is discharged at the die for 3D printing, new material is fed into the extruder. This can be done continuously or at intervals or as required depending on the above measurements.

A particularly advantageous form of an extruder for 3D printing results from an upright/vertical arrangement of the planetary roller extruder as it is depicted and described in the DE19534813 C2.

The housing of the uprightly/vertically arranged extruder can have a generous hollow space at the upper end in which even difficult material can easily accumulate. The planetary spindles preferably extend at least partially into the hollow space so that the planetary spindles can seize the material and pull it into a planetary roller extruder module/planetary roller extruder section arranged uprightly/vertically below it. Thereby, the planetary spindles mesh with the external toothing of a central spindle and the internal toothing of the extruder module housing/extruder section housing.

There is a filling level probe in the hollow space provided above, which gives an immediate signal for the supply of material if the level falls below a selected level.

The material is heated and melted in the planetary roller extruder module/section and conveyed down to a die. For the heat treatment a heating of the module housing in the feed area is helpful.

After the initial heating, the deformation of the material leads to further heating and melting on the further way down.

Optionally, the die is conical and has a tapered discharge end. This form is aerodynamic. The length of the die in the axial direction is preferably designed as a function of the diameter of the die. A small length is provided for small diameters and a large length for large diameters. The outlet opening of the die depends on the width of the melt strand/thread/tape to be discharged.

The inlet opening of the die depends on the size of the extruder with which the material intended for printing is melted. The slimmer the cone, the more aerodynamic the die.

However, a die without conicity can also be used. There is no conicity if the die is formed by a cylindrical boring in the cylindrical end wall of the extruder on the outlet side.

In the execution example, the die can be moved in the axial direction of the extruder. The displaceability serves to open the die completely or partially or to close it completely or partially.

The die is optionally designed in a straight guidance. For this purpose, a rail or profile can be provided that runs parallel to the die axis. Optionally, several rails or profiles are provided, which are spaced apart from each other and run parallel to the die axis.

If several profiles are used, simple round profiles can be used as a guide.

When using a single rail or profile, a cross section for the rail or profile is preferably selected, which prevents the die or its holder from a rotation around the longitudinal axis of the rail or profile, but which allows a movement in the longitudinal direction of the rail or profile. The die or its holder can embrace the rail or the profile or can reach into the rail or the profile.

Optionally, the guide also has the form of a slide.

The slide can be a linearly moved slide or also a rotary slide. The rotary slide can be pivot-mounted on a bolt or axis or pin or in some other way. Such a bearing can also be a ring or collar or cylinder which surrounds a disk-shaped slide on the outside.

The guide can also be formed by a swivel arm. Then the die is hold with the swivel arm.

It is then advantageous if the central die axis is aligned with the central axis of the central spindle tip in the closed position. The closed position is the position in which the die rests closed on the central spindle tip. To open the die, the die is lifted from the central spindle tip by means of the swivel arm. Thereby, the influence of a change in the central axis position of the die with respect to the central axis of the central spindle tip is negligible.

The linear die movement can also be carried out with the help of a robot. Well-known robots have an arm that is multi-flexible so that movements can be carried out in any direction. Of course, a robot can do much more than just execute a straight-line movement. Its construction and control are correspondingly complex. Due to the high number of pieces of commercially available robots and the associated serial production, such a robot is still cheaper than another die guide that is manufactured in single-part production.

An electrically controlled drive is provided for the movement of the swivel arm, which reacts to short control impulses.

When the die is open, melt flows as a melt thread or as a melt tape or melt strand on a work table that can be moved crosswise to the central axis of the central spindle tip and at the same time in the direction of the central spindle tip. The movements of the worktable and the die are controlled in such a way that a 3D molded part is created with the discharging melt thread/tape/strand.

A die with several changeable outlet openings is advantageous for the application of printing on structures/buildings. With large outlet openings, large quantities of melt can be discharged and a large building work can be achieved.

At the same time, the die can be equipped with smaller outlet openings, for example for thinner melt threads.

The changeability of the different outlet openings is an advantage. The outlet openings are preferably exchangeable during a production process. Thus, when constructing a building, a floor with a high melt capacity can be produced, while adjacent thin walls are better produced with a small outlet opening and correspondingly low output.

Likewise, in the manufacture of the hollow walls explained above, it may be functional to produce the outer layers of the wall with a larger die outlet opening and the inclined struts/chambers connecting the layer with a smaller die outlet opening.

Such a die can be formed by a slide which is provided with an adjustment drive and is computer-based controlled. The slide can have a cylindrical shape and is located in a housing with a boring that matches the slide. The slide has various (small and large) through borings which proceed in a distance of each other crosswise to the longitudinal axis of the slide. The slide can also have die openings inclined to the central axis of the extruder. Die openings with different inclinations can also be provided. With die openings inclined in this way, the melt threads, and melt tapes/melt strands can also be deposited at a different location than in the case of a die opening, the axis of which is aligned with the central axis of the extruder.

The slide is located crosswise to the die axis, slidable and rotatable on or in the die. By moving the slide, for example by moving it in longitudinal direction, the appropriate boring can be brought into position. The die can be closed or opened by turning it.

The die is also optionally combined with a ball valve as a control valve for the closing and opening. The die can also be designed as a ball valve. There is a ball in the ball valve or die with a passage opening. By turning the ball, the passage opening is reduced or closed or opened. The ball can also perform further tasks. For example, several different passage openings can be placed in the ball. These openings are made at different points on the ball and directed through the center of the ball. It is of advantage if all the borings lie on a circle on the circumference of the ball, so that different passage openings can be brought into the melt flow by rotating the ball. This can be used to adjust the melt flow and to shape the melt strand. Instead of the ball, a conical closure body can also be arranged in the valve or in the die which is provided with one or more passage openings in the same way as the ball, but is easier to manufacture than the ball and easier to bring it in a sealing contact with the surrounding shell.

Optionally, a robot arm can also be used as die in that the robot arm is provided with a passage opening for the melt and is mounted on the outlet opening of the extruder, so that the melt flows through the robot arm and can be directed from the robot arm to any position.

Optionally, the die can also be formed by a rotatable and/or swiveling and/or displaceable cover, which is provided with a large number of die openings, which can be brought into position by rotating or swiveling or displacing the cover in front of the extruder outlet. Thereby, smaller and larger die openings and die opening with different cross-sectional shapes are provided. This means that a different cross-section can be given to the emerging melt strand/tape/thread, so that, for example,

melt threads occur in one case and melt tapes occur in the other case. Like the slide, the die openings can be aligned with the central axis of the extruder or be inclined to it.

The rotatable and/or swiveling cover can be guided and held in the middle and/or on the outer edge. In die middle, the guide and holder can be formed by a bolt/journal/mandrel/axis. At the edge, the guide and holder can be formed by a ring/collar/cylinder.

The extruder outlet is opened and closed by swiveling or rotating a closed cover part in front of the extruder outlet.

The dies are heated or not heated.

Unheated dies are dependent on the melt remaining meltable in the die or that the die is cleaned after each melt discharge/melt flow. The melt remains liquid in unheated dies if an interruption in the melt flow does not cause a cooling below the melting temperature. The cooling until solidification of the melt depends on the time and the initial melt temperature. If there are interruptions only for a short time, the fluidity of the melt remains ensured. The usual melt temperature during the extrusion process is at least 5 degrees Celsius, preferably at least 10 degrees Celsius, even more preferably at least 15 degrees Celsius above the melt temperature and most preferably at least 20 degrees Celsius above the melt temperature at which the plastic becomes liquefied.

It is advantageous to set the melt temperature during the extrusion operation in that way that an interruption period of at least 2 seconds, preferably of at least 4 seconds, even more preferably of at least 6 seconds and most preferably of at least 8 seconds is possible. This considerably simplifies the handling of the device.

As an alternative or in addition, a heating of the die is provided. If the die is heated, the cooling of the melt in the die can slow down in case of an interruption, so that a longer interruption is possible. In extreme cases, the heating can be designed so that no cooling of the melt in the die occurs. However, an interruption is preferably kept short in order to avoid negative effects of the temperature on the molecular structure.

For the movements of the die, stepper motors are of advantage. Modern motors have a digit rate of up to 400 steps per second with high accuracy.

If the entire extrusion line has to be moved during the manufacture of buildings, servomotors can also be suitable, which can also move these loads within a short reaction time and high accuracy.

Optionally, there is also a die in front of the extruder outlet, which can be—area by area—swiveled in all directions. Thereby, the die consists of a connection part at the extruder outlet, a joint and a die outlet part. The melt flows through the connection part, through an opening in the joint and the die outlet part.

Optionally, the joint can simultaneously form the connection at the die outlet and/or the die outlet part.

In addition, the joint can be formed as a spherical joint.

A section of a hollow sphere can also be considered as a die. Hollow spheres have a spherical shape outside and a spherical hollow space inside with a common center in relation to the outer form, so that there is a spherical shell. A section of this hollow shell is used.

It is optionally provided that the section of the hollow shell slides on the end of a melt feed pipe, which on the contact surface with the section has the same radius as the section of the hollow shell.

The section of the hollow shell is provided with different die openings. The die openings are distributed over the shell surface of the section. By displacement of the section on the end of the melt feed line, another die opening each can be brought in an aligned position with the opening of the melt feed line or also a closed part of the section of the hollow shell for closing the melt feed line in front of its opening.

The movement of the hollow shell section can be controlled by means of power pistons. For example, three power pistons, jointly arranged, can be evenly distributed around the circumference of the hollow shell section so that they can displace the hollow shell section in any direction and brace it with the head of the melt feed line in the desired position.

The hollow shell section is optionally supported with a guide on the side facing away from the melt feed line. The guide facilitates the movement of the hollow shell section.

For the slides and hollow shell sections, which can bring other die openings in front of the melt feed line by displacement, the smallest possible adjustment paths are of advantage. This applies in particular to a point-wise laying of the melt. The adjustment path between two adjacent slide positions or hollow shell section positions is preferably less than 10 mm, even more preferably less than 8 mm and most preferably less than 6 mm.

The emerging melt usually encounters melt that has already cooled down completely or partially. So that the precondition for the connection of the new melt with the melt that has already been laid is given, a heating of the previously laid melt is provided at the contact surface before the contact with the new melt. This can be done by means of an electrically operated heating wire, which can optionally be attached to the die and extends closely above the surface to be heated.

Another option for reheating the previously laid melt is to apply hot air to the contact surface. The hot air can advantageously also escape in some distance from the contact surface. This is harmless for other areas of the molded part and facilitates the supply of hot air.

The contact surface can also be heated by contact with a heated object that slides or rolls on the melt threads/melt tapes/strands that have already been laid and cooled.

### BRIEF DESCRIPTION OF THE DRAWINGS

FIG. 1 shows an extrusion line.

FIG. 2 shows a feed hopper detail of FIG. 1.

FIG. 3 show an actual hopper of FIG. 1.

FIG. 4 shows a lower end of a housing.

FIG. 5 shows a cover slidably arranged in a housing of an extruder.

FIG. 6 shows a cover and an outlet opening with a tip of a central spindle.

FIG. 7 shows a cover and an outlet opening in combination with a differently shaped tip of a central spindle.

FIG. 8 shows a cover and an outlet opening in combination with a further tip of a central spindle.

### DETAILED DESCRIPTION

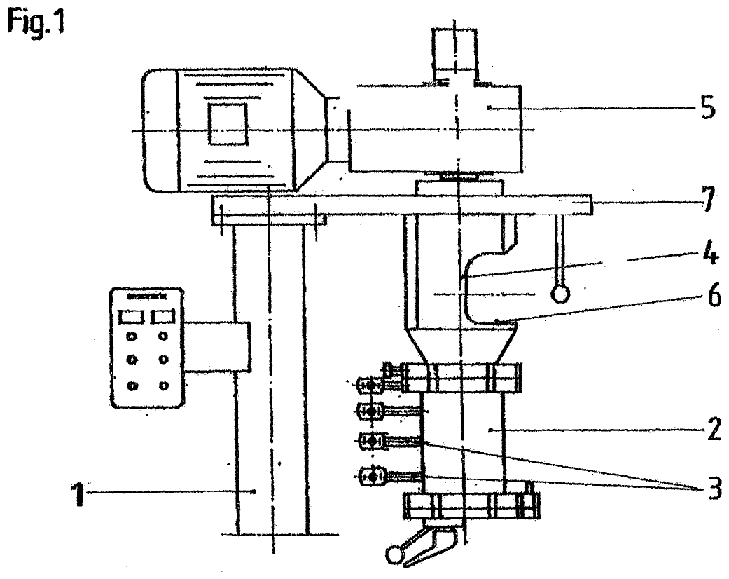

Referring to FIG. 1, on a column 1, a swivel arm 7 is swiveling attached. The swivel arm 7 carries the motor and gear for a planetary roller part 2. The planetary roller part 2 is provided with a feed hopper 4 which has a lateral feed opening 6 in the form of a mouth. 3 denotes the inflows and outflows for heating and cooling media.

The planetary roller part 2 has a lockable outlet which will be explained below. The planetary roller part 2 has in usual design a housing, a central spindle and planetary spindles which mesh due to suitable toothing both with the central spindle and with an internally toothed liner arranged in the housing. In the execution example, the pitch diameter of the internal toothing is 30 mm. The pitch diameter of the internal toothing also identifies the construction size, here construction size 30. In other execution examples, the construction size can be larger, for example 50, or smaller.

In the execution example, the number of planetary spindles is 3. The planetary spindles are evenly distributed around the circumference of the central spindle. At a usual number of 5 planetary spindles, this includes a reduction of the planetary spindle trimming by 40%. In other execution examples, the reduction can be more or less.

There is so much distance between the planetary spindles that the extruder can keep running when the die is closed or only partially opened and the excess melt conveyed against the die flows back as a leakage flow between the planetary spindles until the planetary spindles seize the melt that has flowed back and feed it again in the direction of the die. If the die is not yet open, the backflow/leakage flow is repeated.

The backflow/leakage flow is advantageously used in order to achieve a perfect melt mixture when starting the extruder and at closed die before the die will be opened. Then it can be operated without start-up losses. The start-up loss is easier to absorb with other extrusion processes than when producing a 3D print on a base/worktable. In the case of start-up losses, insufficiently prepared melt would be deposited on the base/worktable. Or the worktable would have to be moved out of the working direction of the die and the melt loss resulting from the start-up would have to be disposed of without contamination. Contamination-free means that the system should not be contaminated by the unusable melt that occurred during starting-up.

A further advantage of the backflow/leakage is obtained when the leakage flow extends as far as possible to the feed hopper through which feed material is fed into the extruder. There is still a high friction of the solid particles. This friction is drastically reduced by the melt flowing back. The backflow/leakage acts like a lubricant between the solid particles. In addition, the mixture improves.

The printing can advantageously be carried out not only with the extruder standing vertically, but also with the extruder standing horizontally or with the extruder standing inclined. Printing with an upright/vertical extruder has the advantage that the die can be brought close to the surface on which the melt is to be deposited. This facilitates accurate printing and simplifies construction for the device. The same applies to an inclined arrangement of the base/worktable. The horizontal arrangement and movement of the base/worktable also has considerable advantages.

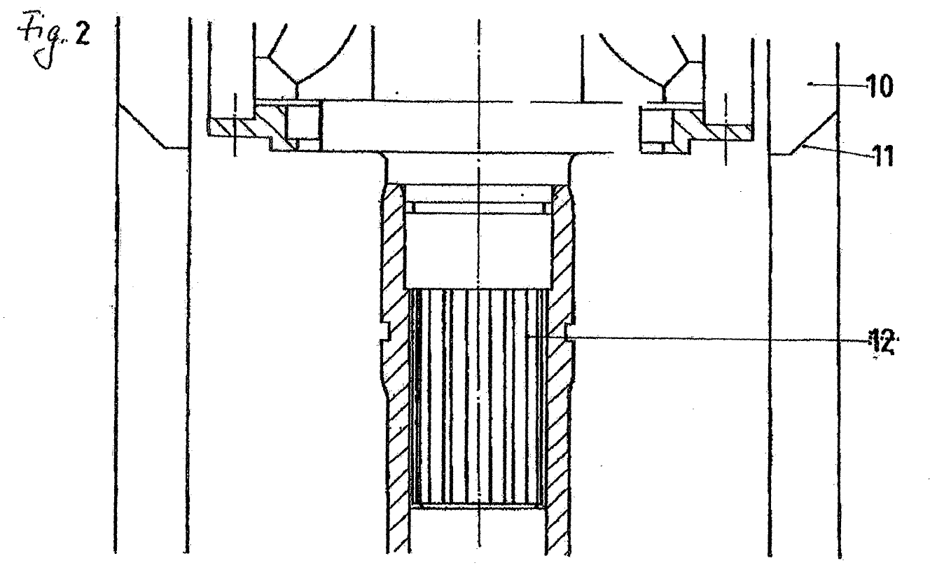

FIGS. 2 to 4 show not to scale details of the extrusion line according to FIG. 1.

FIG. 2 shows the feed hopper with a housing 10 which is fastened to the swivel arm 7 with an upper flange. The swivel arm carries a drive 5. A driving shaft 12 leads from the drive to the central spindle of the planetary roller part 2. The contour of the opening 6 in FIG. 2 is referred to as 11.

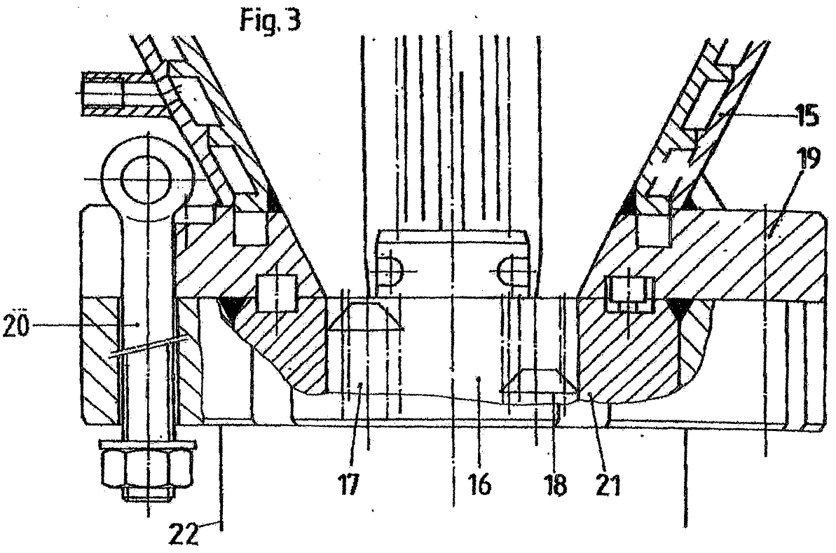

The FIG. 3 shows the actual hopper 15 of the material feed 4. The central spindle is labeled 16, the planetary spindles 17 and 18. The planetary spindles 17 and 18 have different lengths, so that they project into the hopper 15 at different heights. This gives the planetary spindles an advantageous feed behavior in relation to the material supplied into the hopper.

In operation, the rotating planetary spindles slide on a stop ring. The housing 22 of the planetary roller part 2 is detachably attached to the lower edge of the feed hopper 4 by means of swiveling screws. The swiveling screws make it easier to loosen and fasten by swiveling them in or swiveling them out of engagement.

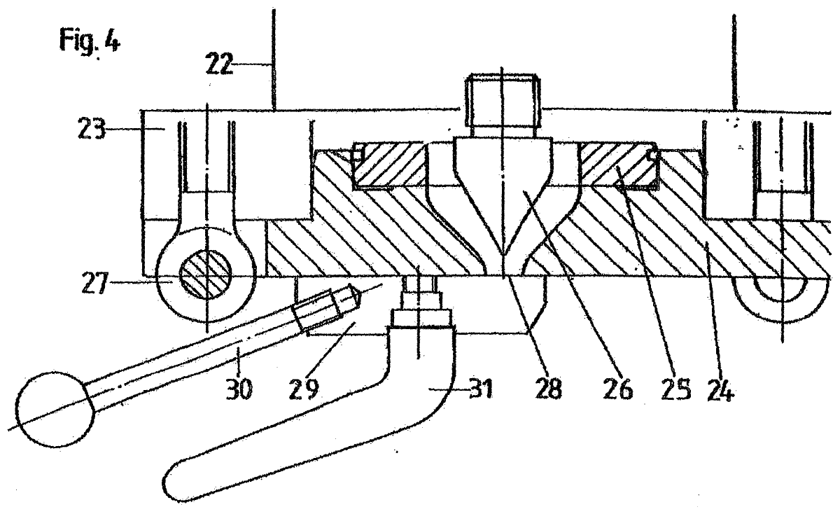

FIG. 4 shows at the lower end of the housing 22 a flange 23 which supports the stop ring 25 for the planetary spindles. The central spindle ends in a tip 26, which defines the outlet opening 28 of the extruder in a screwed-on cover 24. The cover 24 forms a die with the discharge opening and a closure 29. The swivel screws 28 in turn serve as screwing for the cover. There is a rotatable closure 29 on the cover. The closure 29 can completely or partially open or completely or partially close the outlet opening 28 of the extruder. In the execution example, the closure is brought into the desired position by hand with a lever 30. There the closure can be locked with another lever 31. The arrest is locked by a screwing.

When using the above described system for 3D printing of molded parts with plastic melt, the need of melt for covering a melt thread on a base/work table or for laying on a molded part that is being manufactured is estimated by the service personnel and the outlet opening is adapted manually to the need. This can be quite accurate, because excessive amounts of melt or insufficient quantities of melt become immediately visible during printing on the construction progress of the construction part.

The base/worktable can be moved horizontally in all directions. For the horizontal movement, the base/worktable in the execution example is held in two linear guides, one of which is held in the machine frame and carries the other linear guide. In addition, in the execution example, the extruder is also held in a height-adjustable manner with the swivel arm 7 on the column 1. For this purpose, the swivel arm 7 is guided on the column 1 and provided with a not shown lift drive.

For tests, the base/worktable can be moved by hand in order to find out the optimal laying for the melt tape for each molded part. Once this optimal laying of the melt tape has been determined, the movement can be programmed into a control system for a movement drive of the base/worktable and the lift drive of the swivel arm. In another execution example, the control system is designed in such a way that it saves the data of the manual movement and retraces it upon request/at the push of a button. The movement drive for the horizontal movement can be uncoupled from the base/worktable for manual movement or can be coupled with the base/worktable for automatic movement. In the execution example, the lift drive remains coupled to the swivel arm during manual tests.

In the execution example, the drive for the horizontal movement consists of two servomotors. A servomotor is assigned to each linear guide. The servomotors are standard step-servomotors. The control system acts on both motors, and also on the lifting motor.

In another execution example, instead of the closure 29, a slide is provided for automation, which is moved by means of a step switching system. The step switching system is operated as required, whereat the melt requirement is being determined in previous test series.

In yet another execution example, the need of melt is calculated by measuring a sample and the step switching system of the slide is controlled with the data obtained.

In yet another further execution example, the need of melt is determined using a computerized 3D construction, and the step switching system of the slide in thus controlled.

FIG. 5 shows a further execution example. Instead of the cover firmly screwed to the extruder housing, a cover 38 is provided which is slidably arranged in the housing of the extruder. The cover 38 is guided to a not shown boring of the housing and at the same time sealed against undesired melt leakage. In the execution example, the seal is formed by a membrane made of spring steel. The resilience of the membrane is designed for the necessary adjustment way of the cover 38 to open and close the die.

The cover 38 has a computerized adjustment drive. The cover forms a die with the opening 50. The adjustment of the cover 38 serves to control the opening gap between the conical opening 50 of the cover 38 and the conical tip 35 depending on the requirement. As the demand decreases, the gap is reduced. The gap increases, as the demand increases. The requirement is determined using a computerized 3D construction. The control system of the movable cover 38 can be fed directly with the data from the calculation of requirement.

FIG. 5 also shows schematically a base/worktable 39 on which the melt escaping as a thread from the opening is laid. The base/worktable 39 can be moved horizontally in all directions and also vertically. The vertical movement is provided in order to maintain a constant distance between the melt outlet from the extruder and the surface on which the melt thread or the melt tape will be laid as the molded part grows. In the execution example, the surface is always upright/vertical under the melt outlet. When building up the molded part, this is achieved by displacing the base/worktable 39 horizontally with the growing molded part until the relevant surface lies exactly below the melt outlet.

In the execution example, the melt tape has a width of 4 mm and a thickness of 1.5 mm. The associated die is adapted to the cross section. In other execution examples, other die cross-sections are used, for example round die cross-sections. In a first layer, two melt tapes with a width of 4 mm are laid side by side to a total with of 8 mm. In the next, second layer, a die is first used, through which a melt tape with a width of 2 mm and a thickness of 1.5 mm is laid. In parallel, a melt tape with the original width of 4 mm and the same thickness is laid, aside to it another melt tape with a width of only 2 mm, so that the three melt tapes together also have a width of 8 mm. Thereby, the middle melt tape of the second layer overlaps the two melt tapes of the first layer. In the third layer, two 4 mm melt tapes are again laid aside, which overlap with the melt tapes of the second layer. The laying of 2 or 3 melt tapes is repeated in the next layers. With the overlap, the accruing wall is given a greater strength than without an overlap.

According to FIG. 5, the tip 35 of the central spindle and the outlet opening 50 have the same conicity. Thereby, the end 36 of the tip is so small that the tip 35 protrudes in closed position opposite to the cover 38 with the end 36.

However, if the end 37 of the tip 35 of the central spindle is much larger, then the end 37 of the tip lies back opposite to the cover 38 in the closed position.

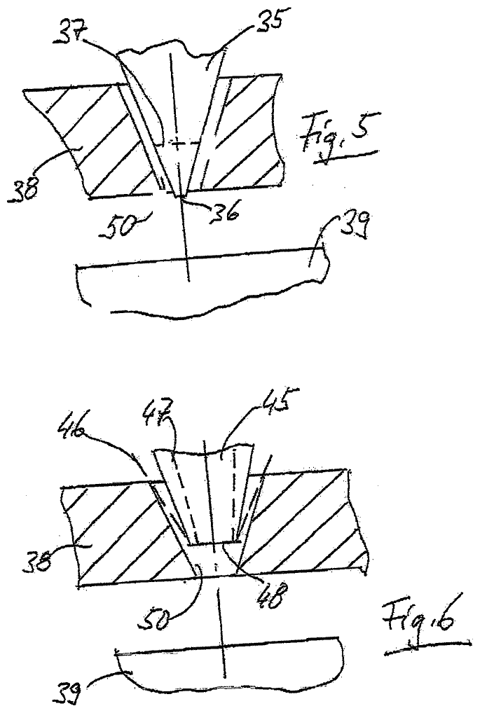

FIG. 6 shows at the same cover 38 and outlet opening 50 a tip 45 of the central spindle with different conicities. At a conical shell 47 shown in dashed lines, the end 48 having a smaller area of the tip 45 can protrude through the outlet opening in the closed position, so that the lower edge touches the conical shell 47.

If, however, the tip 45 has a conical shell with the conicity 46 shown in dashed lines, the upper edge of the cover 38 contacts the conical shell 46.

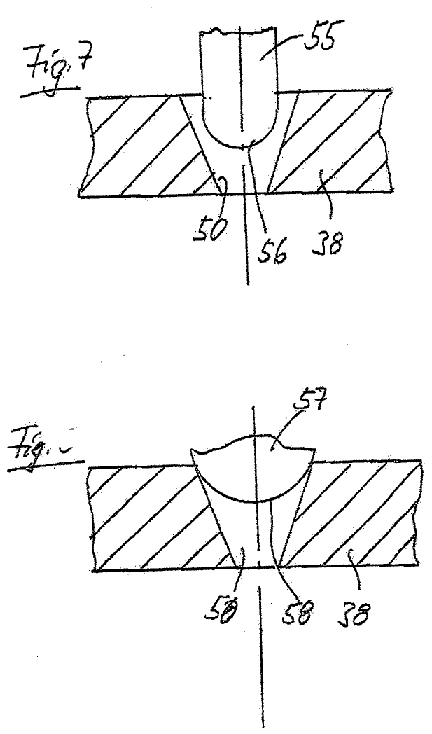

In the execution example according to FIGS. 7 and 8, an identical cover 38 with the same outlet opening 50 is combined with other tips of the central spindle. FIG. 7 shows a tip 55 with a spherical end 56 which, in closed position, rests on the inner surface of the outlet opening 50. The spherical shape of the tip 55 simplifies the closing motion, as for the closing movement no plane-parallel position of the cover to the housing is no longer necessary. This also makes a swiveling movement suitable for closing the die.

FIG. 8 shows a tip 57 with a spherical end 58 which rests on the upper edge of the cover 38 due to a large diameter.

1.-36. (canceled)

37. A method for 3D printing, comprising:
producing a melt of liquid plastic by liquefaction of a plastic that is mixed with additives, additions and fillers in an extruder;
applying the liquid plastic through a die that can be closed;
effecting a backflow or leakage of the melt in the extruder when the die is closed; and
creating a melt tape or a melt thread or a melt strand or a melt point by extruding the melt through the die.

38. The method according to claim 37, wherein the extruder is a single-screw extruder or a twin-screw extruder or a planetary roller extruder.

39. The method according to claim 38,
wherein the extruder comprises a screw or a central spindle with a tip at an extruder outlet, and
wherein an outlet opening is followed by a closeable die in a flow direction of the melt.

40. The method according to claim 39, wherein the die is closed or opened by one or more of
a displacement of the screw or central spindle,
a movement of the die, and
by a slide or a hollow shell section.

41. The method according to claim 39,
wherein the die can be moved in an axial direction of the screw or the central spindle against the tip of the screw in order to completely or partially close the die and
wherein the die can be moved away from the tip of the screw or central spindle in order to completely or partially open the die.

42. The method according to claim 39,
wherein the die can be moved in an axial direction of the extruder to open and close.

43. The method according to claim 37,
wherein the melt escaping from the die is placed on a movable base or worktable, with which all other movements for printing a workpiece take place.

44. The method according to claim 37,
wherein the melt escaping from the die is deposited on a stationary building area and the extruder together with the die can be moved over the building area to produce a structure work.

45. The method according to claim 37,
wherein the die is exchangeable at least at an outlet opening in order to give the melt tape or the melt thread or the melt strand or the melt point a different cross section.

46. The method according to claim 45,
further comprising exchanging the die during production of a molded part.

47. The method according to claim 45, further comprising
providing a linearly movable slide with at least one die opening at the outlet opening or
providing a rotatable or swiveling cover with at least one die opening at the outlet opening or
providing a displaceable hollow shell section with at least one die opening at the outlet opening.

48. The method according to claim 37, wherein the die includes a plurality of dies which are at least swiveling on an outlet side.

49. The method according to claim 37, wherein the die is a swiveling die, a slewability of which is provided by a spherical joint in the die.

50. The method according to claim 37, wherein a compound is used which at least partially contains a desired mixture proportion for the melt.

51. The method according to claim 37, further comprising adding a flame retardant to the plastic for producing the melt when used on building products or building structure, which are exposed to a fire load in event of a fire.

52. The method according to claim 39, wherein the extruder is arranged with the screw or the spindle being vertical.

53. The method according to claim 37, further comprising measuring a melt consumption and re-filling feed material depending on the measure melt consumption.

54. The method according to claim 37, further comprising one or more of:
measuring a filling degree in the extruder;
measuring a weight of an accruing molded part;
measuring a distance between the accruing molded part and the die; and
measuring a filling level in the extruder.

55. The method according to claim 40, wherein the screw or the central spindle has a tapering tip which extends into the die at least in the closed position of the die.

56. The method according to claim 55, wherein the die has a tapered opening.

57. The method according to claim 37, wherein the extruder is a planetary roller extruder with fewer than a full set of planetary spindles revolving around a central spindle and/or a reduced teeth trimming.

58. The method according to claim 57, wherein a number of planetary spindles amounts at least to 3.

59. The method according to claim 58, further comprising evenly re-distributing the planetary spindles between the central spindle and the surrounding housing after each change in the number of planetary spindles.

60. The method according to claim 57, further comprising reducing the teeth trimming on the planetary spindles by totally or partially removing teeth or by totally or partially interrupting teeth.

61. The method according to claim 37, further comprising re-feeding melt quantities which are not taken off for printing through a bypass.

62. The method according to claim 37,
further comprising building a molded part by laying the melt tape or the melt thread or the melt strand in layers and
wherein the laying the melt tape or the melt thread or the melt strand within a layer is interrupted when the melt tape or the melt thread or the melt strand adjoins a melt strand/thread/tape that has already been laid or is continued at a point where no melt strand/thread/tape has yet been laid.

63. The method according to claim 62,
further comprising a line by line laying within the layers, whereat a reversal takes place when an edge of the molded part is reached.

64. The method according to claim 62,
wherein the laying the melt tape or the melt thread or the melt strand takes place at transition to an adjacent line of a layer without interruption and there is a meandering course of the melt tape or the melt thread or the melt strand.

65. The method according to claim 62,
wherein the melt tape or the melt thread or the melt strand is laid at junctions with other melt strands/threads/tapes in a bracing.

66. The method according to claim 62,
wherein the melt tape or the melt thread or the melt strand has an offset to adjacent melt strands/melt tapes/threads of at least 1 mm.

67. The method according to claim 62,
wherein during construction of a wall a direction of laying the melt tape or the melt thread or the melt strand is adapted to a course of the walls.

68. The method according to claim 37, further comprising producing buildings or structural parts and creating hollow spaces in outer walls.

69. The method according to claim 68, further comprising:
producing an outer layer and an inner layer at the hollow spaces and
producing hollow chambers between the outer layer and the inner layer, the hollow chambers being shaped like honeycombs.

70. The method according to claim 67, further comprising:
providing larger building parts with expansion joints to compensate expansion, the expansion joints being closed with joint tapes,
wherein the joint tapes are welded with the building.

71. The method according to claim 67, further comprising:
providing plastic windows; and
welding or gluing the plastic windows to the building.

72. The method according to claim 71, further comprising:
solvent welding the plastic windows.
